(19) United States
(12) Patent Application Publication
(10) Pub. No.: US 2013/0230624 A1
(43) Pub. Date: Sep. 5, 2013

(54) TREATMENT OF PLANT BIOMASS

(71) Applicants: Mary Ann Augustin, Werribee (AU); Geoffrey John Dumsday, Vermont South (AU); Raymond Mawson, Werribee (AU); Christine Maree Oliver, Werribee (AU); Laurence David Melton, Auckland (NZ)

(72) Inventors: Mary Ann Augustin, Werribee (AU); Geoffrey John Dumsday, Vermont South (AU); Raymond Mawson, Werribee (AU); Christine Maree Oliver, Werribee (AU); Laurence David Melton, Auckland (NZ)

(73) Assignee: COMMONWEALTH SCIENTIFIC AND INDUSTRIAL RESEARCH ORGANISATION, Campbell, ACT (AU)

(21) Appl. No.: 13/807,670

(22) PCT Filed: Jun. 30, 2011
(86) PCT No.: PCT/AU2011/000805

§ 371 Date: May 23, 2013

(30) Foreign Application Priority Data
Jul. 1, 2010 (AU) 2010-902896

(51) Int. Cl. A23K 1/00; A23K 1/12

(52) U.S. Cl. CPC A23K 1/007; A23K 1/12
USPC 426/53; 426/635

(57) ABSTRACT

Lignocellulosic biomass is treated to increase accessibility of the material to enzymes and fermentative processes. Accessibility is increased by physical pre-treatment of the biomass using ultrasound and/or microwave and/or cool plasma. The physical treatments degrade the waxy cuticle of the biomass facilitating enzyme accessibility to cellulose and hemicellulose for conversion to utilizable matter, in nutritive and chemical or biofuel industries. These physical treatments improve enzyme accessibility to cellulose and hemicellulose, for enhancing conversion into a range of feed stocks amenable to further processing.

This invention relates to improvements in the treatment of lignocellulosic materials using sonication.

### BACKGROUND TO THE INVENTION

Lignocellulose is the primary building block of plant cell walls. Lignocellulosic biomass is composed of three major structural polymers: ˜30-40% cellulose (a highly crystalline, linear homopolymer of glucose), 20-30% hemicellulose (an amorphous, branched heteropolymer that includes pentoses (eg xylose and arabinose) and hexoses (primarily mannose)), and 5-30% lignin (a complex, cross-linked polyphenolic polymer). The lignin is further cross-linked to the cellulose and hemicellulose forming a physical seal around the later two components, which is highly hydrophobic and impermeable to penetration by solutions and enzymes. Many plants (eg wheat straw) also contain a significant quantity of wax (ca 1% by weight), which is present on the outer layer (cuticle) of the plant material: wax is usually comprised of a mixture of primarily long chain fatty acids and fatty alcohols, alkanes and sterols. The waxy cuticle forms a robust hydrophobic skin over the surface of the underlying lignocellulose structure. Pre-treatment of the biomass, which causes de-waxing and extensive physical and chemical modification of the lignocellulosic structure, is necessary to improve its susceptibility to enzymatic hydrolysis.

A key challenge in the effective utilisation of lignocellulosic biomass is the requirement for de-lignification (and de-waxing) to increase enzyme accessibility to cellulose and hemicellulose. World production of herbaceous biomass, of which more than 90% contain lignocellulose, amounts to ˜200 billion tons per annum, (Lin and Tanaka, 2006, Ethanol fermentation from biomass resources: current state and prospects, Appl Microbiol Biotechnol 69, 627-642). According to the Food and Agriculture Organisation annual volumes of herbaceous waste (eg from oilseeds, plantation crops and pulse crops) amount to nearly a billion tons per annum (Kuhad and Singh, 2007 Lignocellulose Biotechnology, Future Prospects, I.K. International Publishing House, New Delhi, India). Under-utilisation of the lignocellulosic-containing biomass is due to the complex structure of the lignocellulosic material, which has high biological stability and is recalcitrant to enzymatic degradation.

The use of ultrasound to process plant materials has been examined in recent years. Ultrasonic pre-treatment generates cavitation that disrupts the tissue structure, and strips away/degrades waxy surfaces. The use of ultrasound in lignocellulosic biomass has been studied to improve the disruption of lignincellulose-hemicelluloses interactions, and to improve the susceptibility of lignocellulosic material to biodegradation. The increase in surface area and pore volume due to ultrasound pre-treatment has been shown to improve the yield of extractives and shorten the extraction time. Sonication also has a beneficial effect on saccharification and has been reported to decrease enzyme requirements and increase enzymatic reaction rates due to micro-streaming effects.

De-lignification currently involves the use of toxic chemicals or/and harsh conditions (eg strong bases/concentrated sulphuric acid, nitrobenzene oxidation, cupric (II) oxidation, sulfites/bisulphites, peroxides), which have limited success.

An alternative to the use of thermochemical approaches for de-lignification is the use of biological catalysts such as fungal laccases and peroxidises, often in combination with other processes.

These fungal-derived enzymes are able to degrade lignin through its use as a carbon and energy source. Selective degradation of lignin by these fungi leaves behind crystalline cellulose with a bleached appearance that is often referred to as “white rot”. White rot fungi are basidiomycetes, a diverse fungal phylum that accounts for over one-third of fungal species, including edible mushrooms, plant pathogens such as smuts and rust, mycorrhizae and opportunistic human pathogens.

The use of emerging processing technologies (eg: ultrasound, high pressure, steam, supercritical carbon dioxide, and microwave) for treatment of biomass offers an attractive alternative to the procedures currently used.

Prior art of relevance in the area of processing of biomass include the following Deswarte et al 2006. The fractionation of valuable wax products from wheat straw using CO₂, Green Chem 8: 39-42. Ground wheat straw (0.5-5 mm particle size range) is exhaustively extracted by supercritical carbon dioxide. Extraction efficiency of the wax was 99.9% after ca 100 min.
U.S. Pat. No. 6,333,181 describes the use of ultrasound (2-200 kHz, 10-30 min) to enhance the enzymatic degradation of lignocellulose waste materials (eg plant residues, waste paper) by disrupting the crystalline structure of the lignocellulose, for the production of ethanol. Cellulase requirements were effectively reduced by one third to one half.
U.S. Pat. No. 7,101,691 uses sonication in several different stages of treating grains to extract and ferment starch.
U.S. Pat. No. 7,504,245, describes subjecting biomass, either before or after fermentation, to one or more ultrasonic transducers that generate 3 kW of power and operate at a frequency of at least 17 kHz, to facilitate physical separation or removal of lignin from cellulose for the production of alcohol.
Kumar et al online, Ind Eng Chem Res doi: 10.1021/ie801542g applied pulsed electric field pre-treatment to permeabilise lignocellulosic biomass e.g. switchgrass. Mahamuni, 2009, Intensification of enzymatic cellulose hydrolysis using high frequency ultrasound, The American Institute of Chemical Engineers, 2009 Annual Meeting, November 8-13, Nashville, Tenn.
Revin et al, 2005, Method of bio-conversion of waste vegetable raw material, RU2255979. Pre-ground vegetable raw material is subject to ultrasound (22-24 kHz, 10-15 min) in presence of the fungus (Panus tigrinus).
Sun and Tomkinson, 2002, Characterization of hemicelluloses obtained by classical and ultrasonically assisted extractions from wheat straw, Carbohydrate Polymers 50: 263-271. Pulverised, solvent de-waxed wheat straw powder is subject to ultrasound.
Sun et al, 2004, Isolation and characterization of cellulose from sugarcane bagasse, Polymer Degradation and Stability 84: 331-334. De-waxed sugarcane bagasse is ultrasonicated in the presence of various chemicals to improve cellulose and hemicellulose extraction.
Toma et al 2001 Investigation of the effects of ultrasound on vegetal tissues during solvent extraction, Ultrasonics Chem 8: 137-142. Ultrasound (200 kHz) is used to increase enzyme accessible surface area by particle size reduction.
Toma et al 2006. Ultrasonically assisted conversion of lignocellulosic biomass to ethanol, Post-proceedings, The American Institute of Chemical Engineers, 2006 Annual Meeting, San Francisco, Calif.
Yachmenev et al, 2007, Technical aspects of use of ultrasound for intensification of enzymatic bio-processing: new path to “green chemistry”, 18^{th} International Congress on Acoustics, Madrid, 2-7 Sep. 2007. Ultrasound (20-100 kHz) is used to enhance enzymatic bioconversion of natural fibres.
USA patent publication 0026262. Cellular matter contained within a bioreactor is subject to ultrasonic energy (1-10 kHz during hydrolysis, 1-2000 kHz otherwise) and microbial digestion.
High energy radiation methods, such as electron beams, microwave, γ-ray irradiation, ultraviolet have also been used to enhance digestibility of lignocellulosic biomass but at present are not commercially attractive due to costs (Zheng et al 2009, Overview of biomass pretreatment for cellulosic ethanol production, Int J Agric & Biol Eng 2:51-68).
Gupta et al., 2011, Fungal delignification of lignocellulosic biomass improves the saccharification of cellulosics, Biodegradation 22:797-804. Describes the solid-state fermentation of milled woodchips (1-2 mm) by select white rot fungi in which a 5-13% loss of lignification is achieved over 25 days of fungal treatment.
Sul'man et al 2011, Effect of ultrasonic pretreatment on the composition of lignocellulosic material in biotechnological processes, Catalysis in Industry 3:28-33. Ultrasound (30 kHz, 368 W/cm², 15 min) is applied to sunflower husk in a water medium to destroy lignin (˜83% degradation of the lignin is achieved), then cultivated with Bacillus subtilis (for up to 25 days), which leads to a further 30% degradation of the lignin.
US patent application publication 0111456 describes preparation of biomass (plant/animal/municipal waste) using a series of steps that follow an initial size reduction, followed by pre-treatment (using one or more physical methods, eg ultrasound between 15-25 kHz), then fermentation and post-processing to produce alcohols.

It is an object of this invention to improve the efficiency of cellulose and hemicellulose separation from lignocellulosic material.

### BRIEF DESCRIPTION OF THE INVENTION

To this end the present invention provides a method of processing a lignocellulosic biomass wherein the plant biomass is immersed in an aqueous bath or provided with sufficient moisture and then treated with acoustic energy followed by incubation with appropriate enzymes or fungal extracts wherein the acoustic treatment includes
i) applying a low frequency ultrasound for at least 300 seconds
ii) applying a moderately high frequency ultrasound for at least 300 seconds, either subsequent to the low frequency treatment or simultaneously with the low frequency treatment
iii) Optionally applying a medium frequency ultrasound for at least 300 seconds during incubation

The low frequency is preferably from 10 to 60 kHz, the moderately high frequency is preferably above 200 kHz and the medium frequency is preferably from 60 to 120 kHz. The sonication power used will depend on the configuration of the plant and can be established by conventional design considerations. Usually the sonication power in the incubation stage will be about half that used in the pretreatment stages.

This invention provides a physical means of obtaining accessible cellulose and hemicellulose from lignocellulosic material to facilitate bioconversion into utilisable feedstocks and animal feed. The process parameters for physical treatment are controlled to produce a sufficient extent of de-waxing and lignin degradation, to enable increased enzyme accessibility to cellulose and hemicellulose.

The temperature of the biomass during sonication is preferably from 37 to 50° C. Similar temperature ranges apply during the incubation. The incubation is carried out for more than 2 hours and preferably about 72 hours.

The treatments of this invention obviate the need of harsh chemicals and extreme temperatures and pressures currently used for biomass pre-treatment.

This invention is partly predicated on the discovery that the appropriate use of ultrasound conditions can selectively degrade waxes and lignin:

1) Low frequency ultrasound can physically tease the structure apart following mechanical comminution or microwave disintegration, and physically blast waxy materials from the surface (cf ultrasonic cleaning), and
2) Moderately high frequency ultrasound can sonochemically oxidise phenolic compounds and waxes, and
3) Medium frequency ultrasound can facilitate mass transfer through the boundary layers surrounding the enzymes without mechanically or sonochemically denaturing the enzymes.

The choice of ultrasound conditions used in this invention enables the production of degraded lignocellulosic material, which, when exposed to enzymes, increases production of utilisable substrates.

Medium frequency ultra sound is preferably applied as pulses during the enzyme incubation

The ultrasound conditions are preferably a 2-step program consisting of sequential 1) 40 kHz, 600 s, 2) 270 or 400 kHz, 600 s; or a 3-step program consisting of sequential 1) 40 kHz, 600 s, 2) 270 or 400 kHz, 600 s and 3) 80 kHz (50% power), 60 s every 1800 s for 144 cycles, during enzyme hydrolysis, wherein all steps are operated at 37 or 50° C. (waterbath).

These conditions may be used in combination with other physical treatments (e.g. microwave) to further enhance the lignin degradation process. The rationale behind using microwave is to remove the waxy layer from the surface of the biomass to increase the surface area available for enzyme action.

With the physical processes there is less or no requirement for chemicals used in many prior arts of processing lignocellulosic materials. The invention is a cleaner, greener, and more energy-efficient process. The ability to improve conversion efficiency using physical processes has the advantage of improved utilisation of biomass in a resource-constrained world.

The above physical pre-treatments and the stated conditions for modification of lignocellulosic material have not been previously proposed. In contrast to prior art ultrasound treatments, where high power ultrasound (<50 kHz) has primarily been used to pulverise the lignocellulosic material subsequent to extensive mechanical size reduction, the ultrasound treatments used in this invention have been chosen to selectively de-wax and degrade lignin, while preserving the cellulose and hemicellulose for subsequent utilisation by animals or industry.

The invention utilises low power and medium and high frequency ultrasound (>100 kHz) to selectively de-wax and degrade lignin. It is also the objective of this invention to use low power and high frequency ultrasound for de-emulsification and physical separation of wax and degraded lignin.

Other physical methods (e.g. cool plasma, pulsed electric field, microwave) may be exploited alone or in combination with ultrasound to de-wax and degrade lignin, because of their ability to cause pyrolysis and/or oxidation.

Preferably the pre-treatments are followed by enzymatic degradation of the lignin. Any source identified as containing lignocellulolytic degrading enzymes will be suitable for use in this invention. White rot fungi are a preferred source of these enzymes.

White rot fungi catalyse the initial depolymerisation of lignin by secreting an array of oxidases and peroxidases that generate highly reactive and nonspecific free radicals, which in turn undergo a complex series of spontaneous cleavage reactions.

Major components of the P. chrysosporium lignin depolymerisation system include multiple isoforms of lignin peroxidase (LiP) and manganese-dependent peroxidase (MnP).

LiP and MnP require extracellular H₂O₂ for their in vivo catalytic activity, and one likely source is the copper radical oxidase, glyoxal oxidase (GLOX). The genome sequence reveals at least six other sequences predicted to encode copper radical oxidases (crol through cro6). Beyond copper radical oxidases, extracellular FAD-dependent oxidases are likely candidates for generating H₂O₂.

In addition to lignin, P. chrysosporium completely degrades all major components of plant cell walls including cellulose and hemicellulose. The genome harbours the genetic information to encode more than 240 putative carbohydrate-active enzymes including—
166 glycoside hydrolases,
14 carbohydrate esterases and
57 glycosyltransferases,
   comprising at least 69 distinct families.

### DETAILED DESCRIPTION OF THE INVENTION

Preferred embodiments of the invention will now be described with reference to the drawings in which:

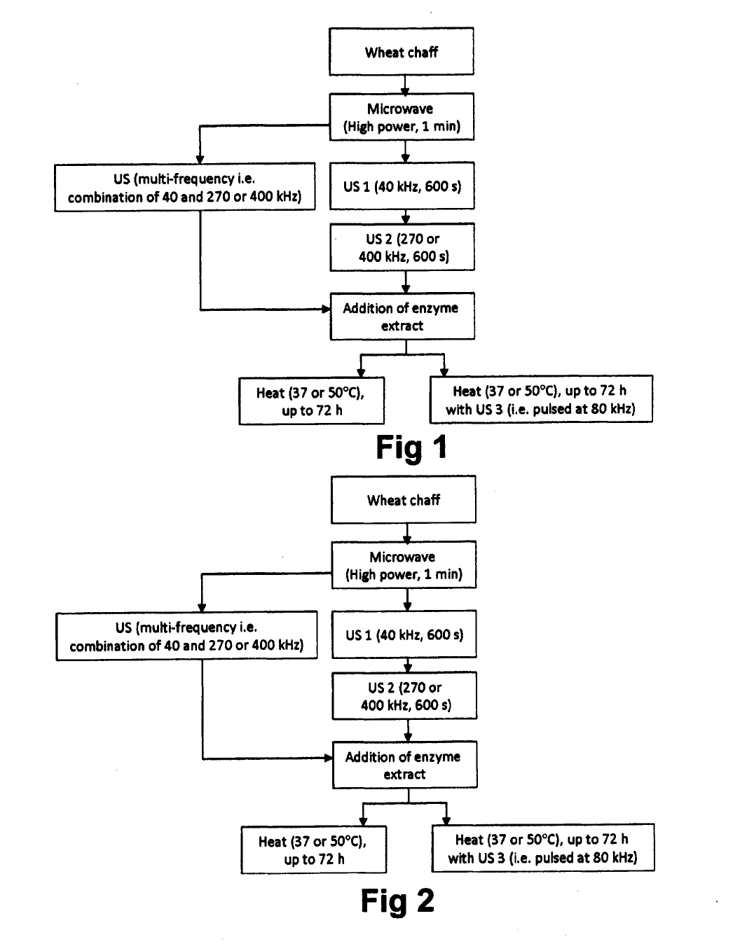

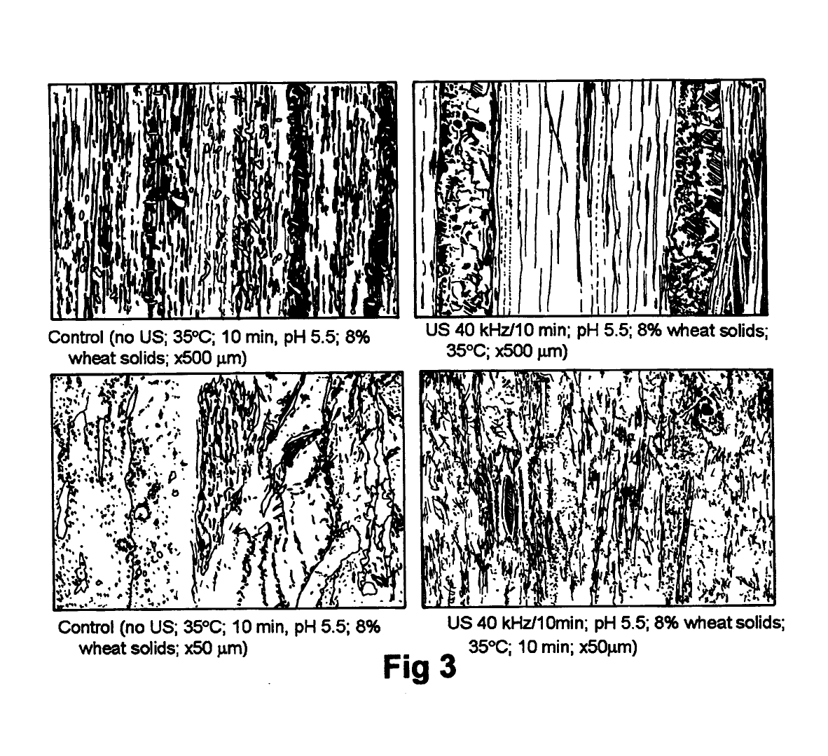

FIG. 1 is a flow diagram of a first method used to assess the efficacy of the invention;

FIG. 2 is a flow diagram of a second method used to assess the efficacy of the invention;

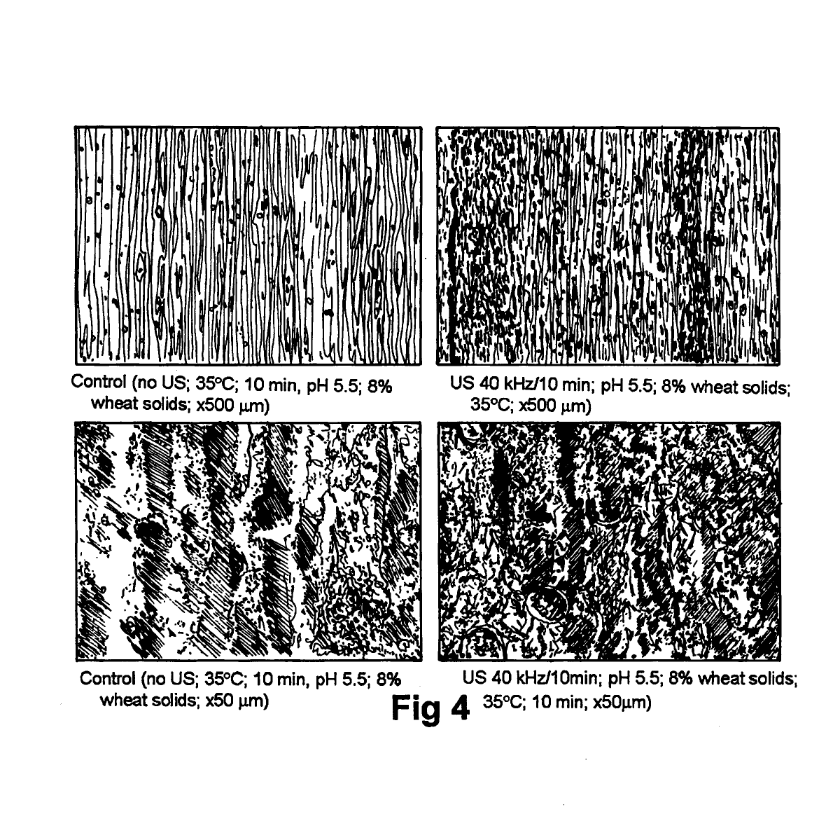

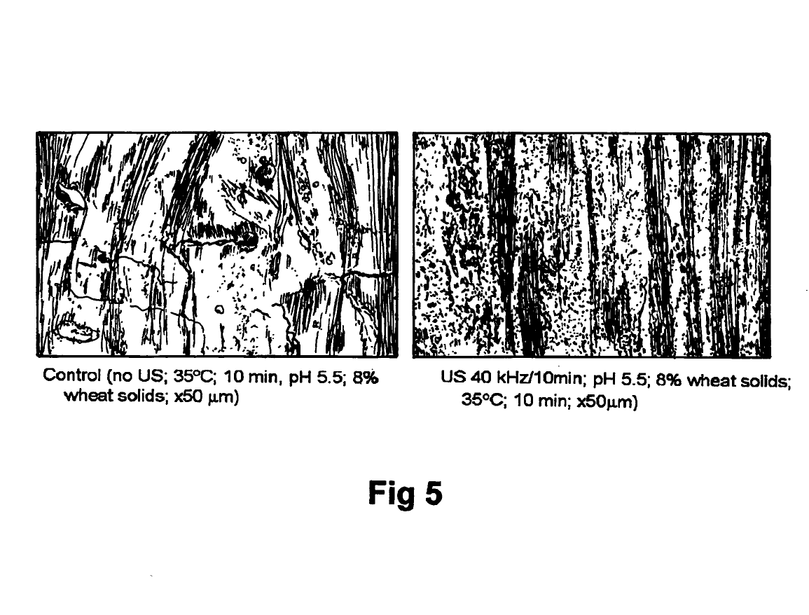

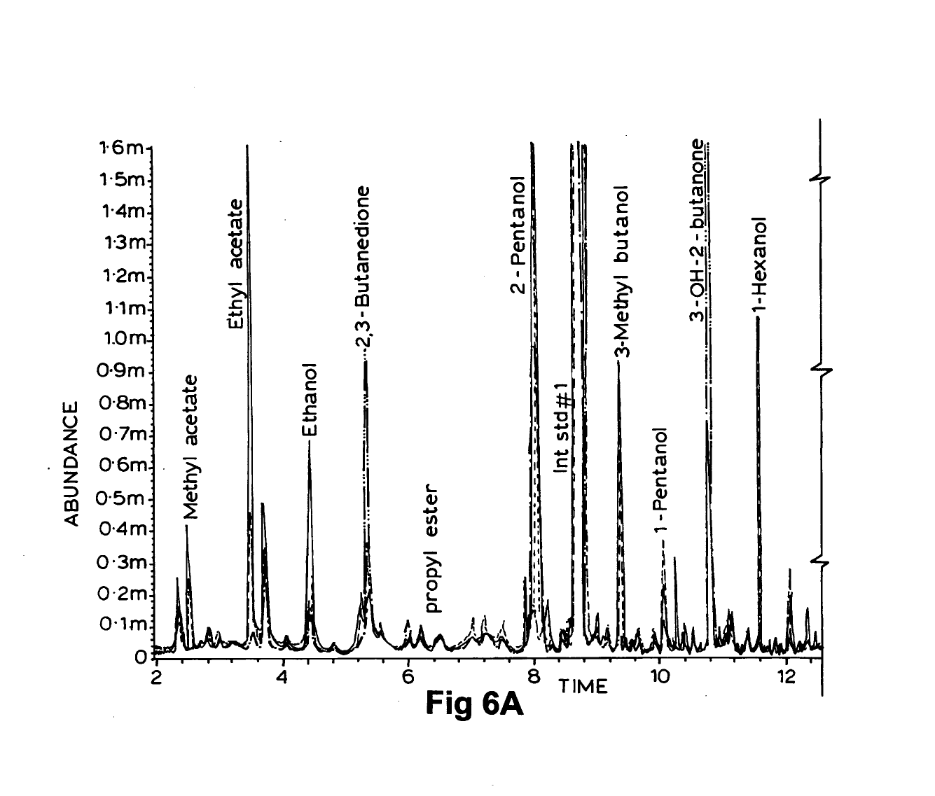

FIG. 3-5 scanning electron micrographs of wheat straw show evidence for pitting, removal of waxy crystals from the straw surface, an increase in visualisation of the underlying cellulose microfilbrils and surface disruption after treatment with ultrasound at 40 kHz/10 min, 35° C.;

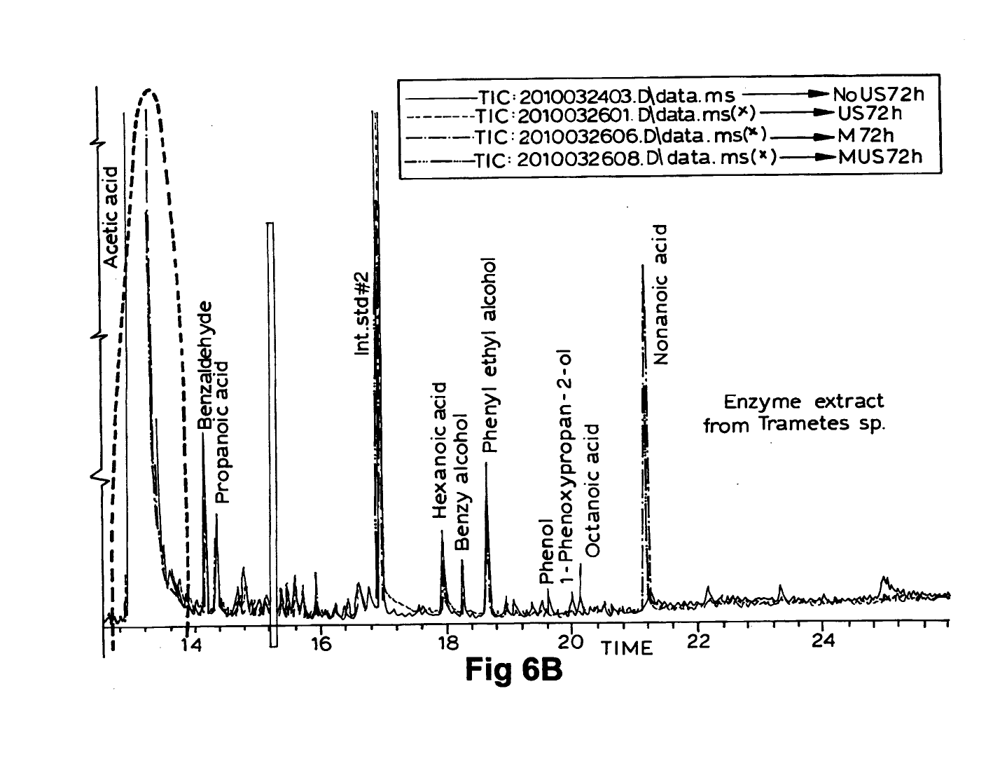

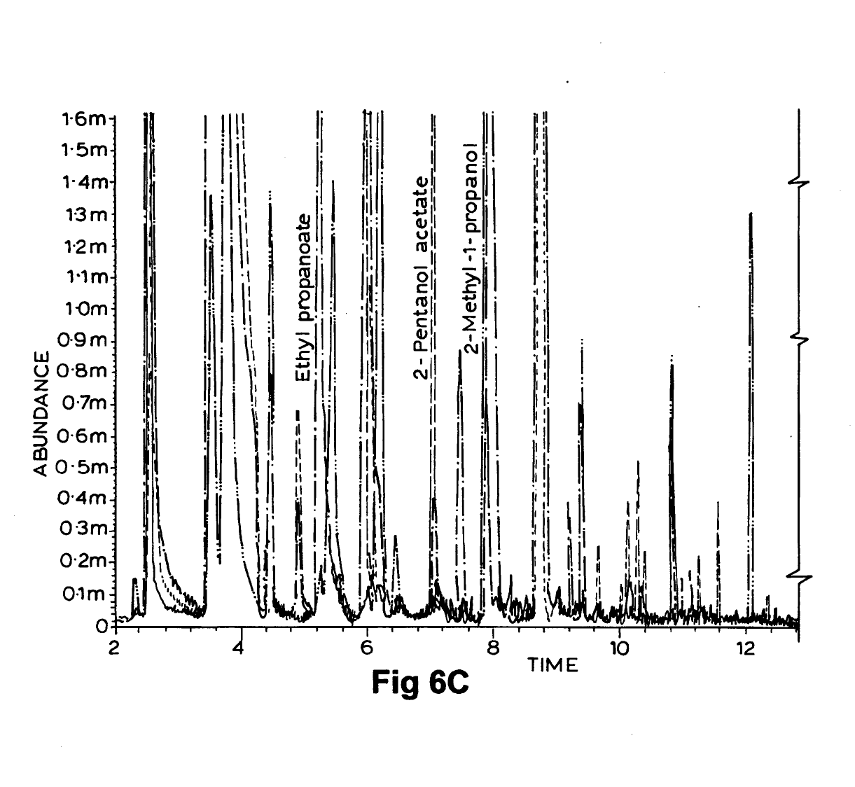

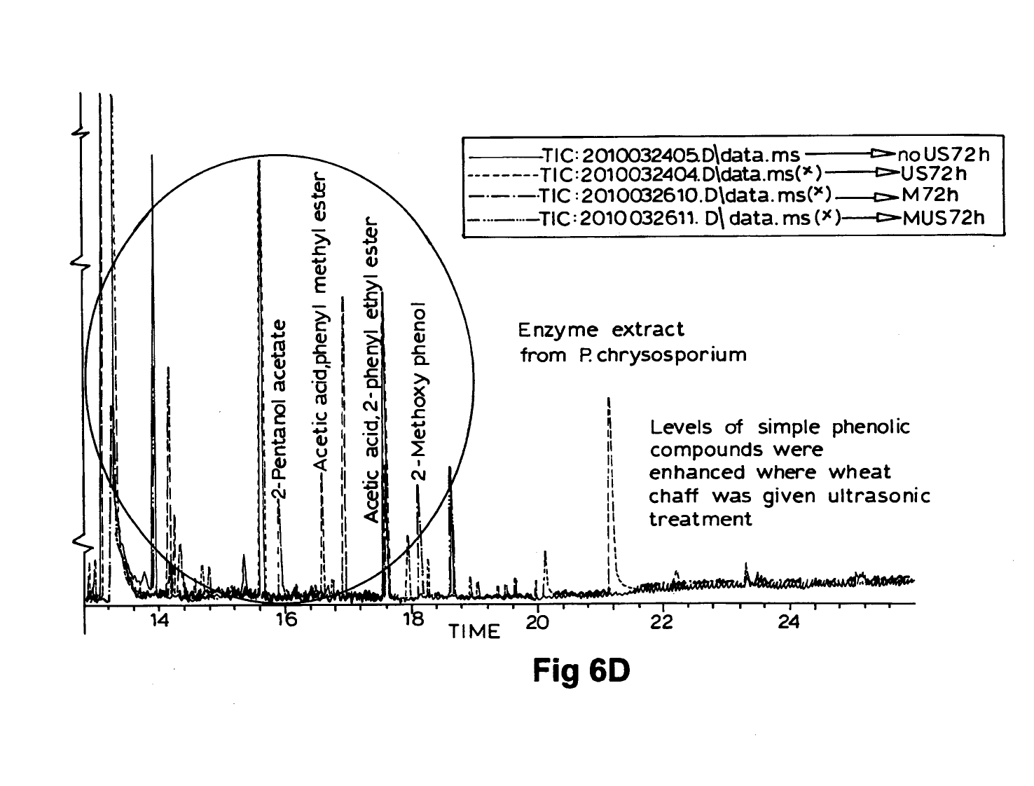

FIG. 6 shows typical profiles of compounds formed during the enzymatic degradation (enzyme extracts T and P) of lignocelluloses;

FIG. 7 illustrates enhanced enzymic degradation of lignocelluloses with ultrasonication (US) treatment as compared to control (NO US/NO enzyme treatment);

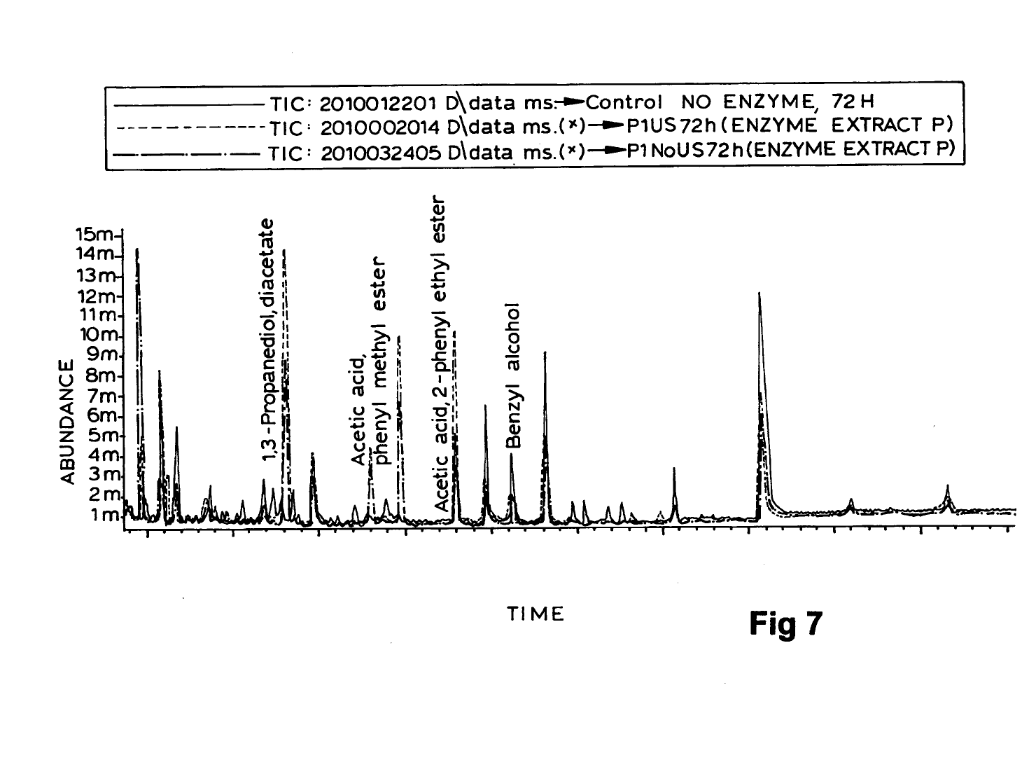

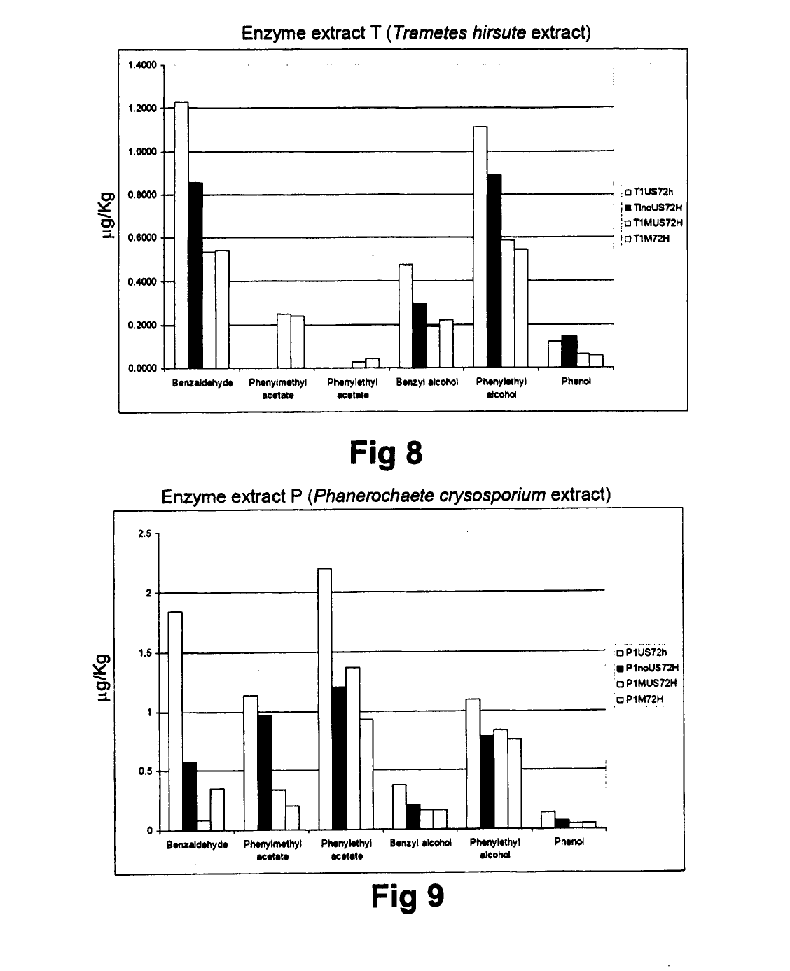

FIG. 8 illustrates the formation of aromatic phenolic-derived compounds detected in the headspace of wheat straw treated by ultrasound with the enzyme extract obtained from Trametes hirsute/versicolor. (M=microwave; US=ultrasound);

FIG. 9 illustrates the formation of aromatic phenolic-derived compounds in the headspace of wheat straw treated by ultrasound with the enzyme extract obtained from Phanerochaete chrysosporium. (M=microwave; US=ultrasound)

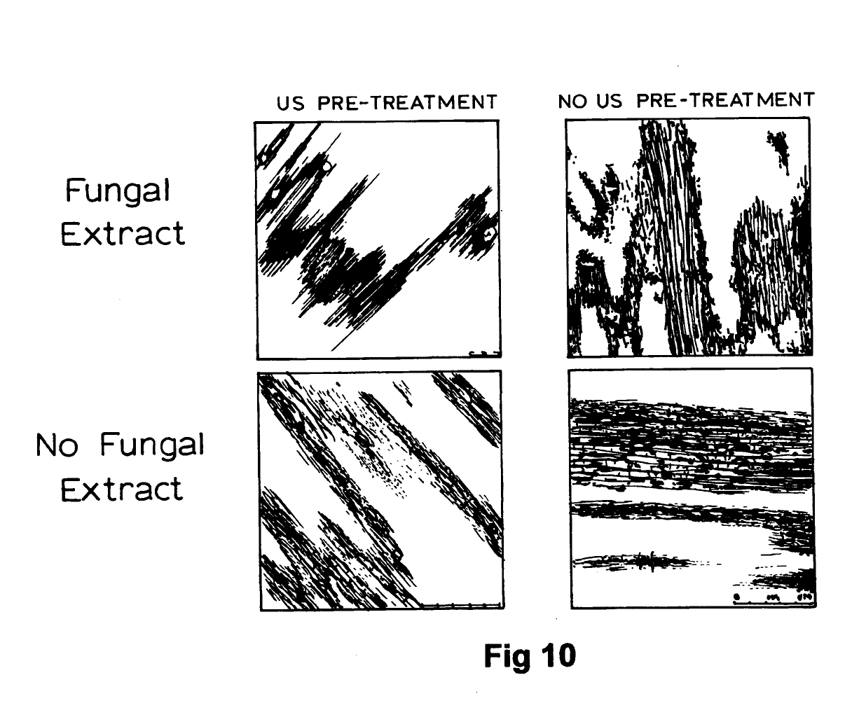

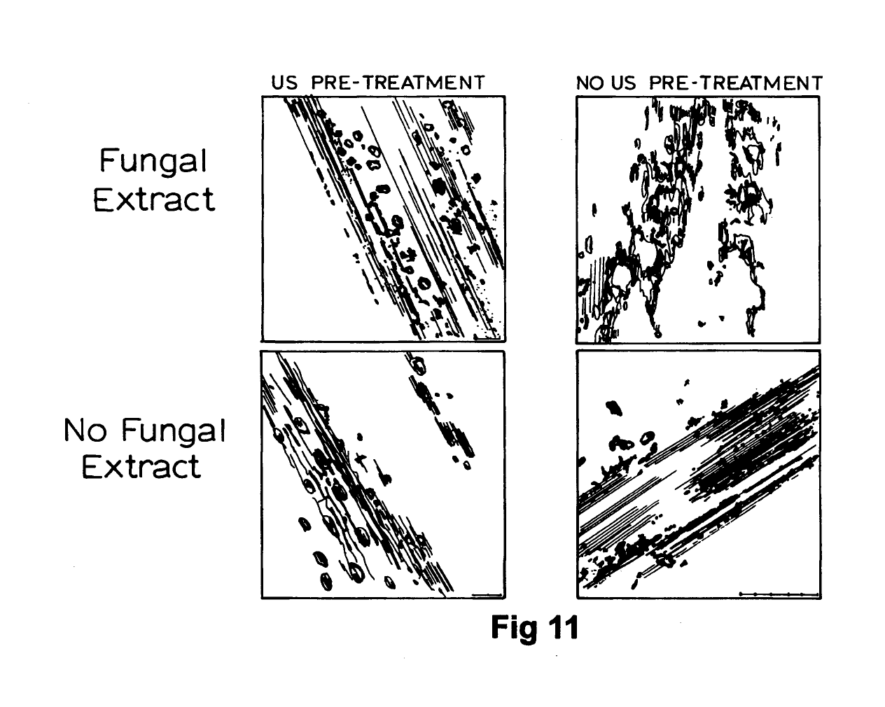

FIG. 10 show confocal micrographs of wheat straw treated by ultrasound with the enzyme extract obtained from Phanerochaete chrysosporium. The samples were visualised by autofluorescence (excitation at λ=488 nm).

FIG. 11 show confocal micrographs of wheat straw treated by ultrasound and the enzyme extract obtained from Phanerochaete chrysosporium. The samples were stained with Nile Red for visualisation of lipid/fat (i.e. wax) (excitation at λ=543 nm).

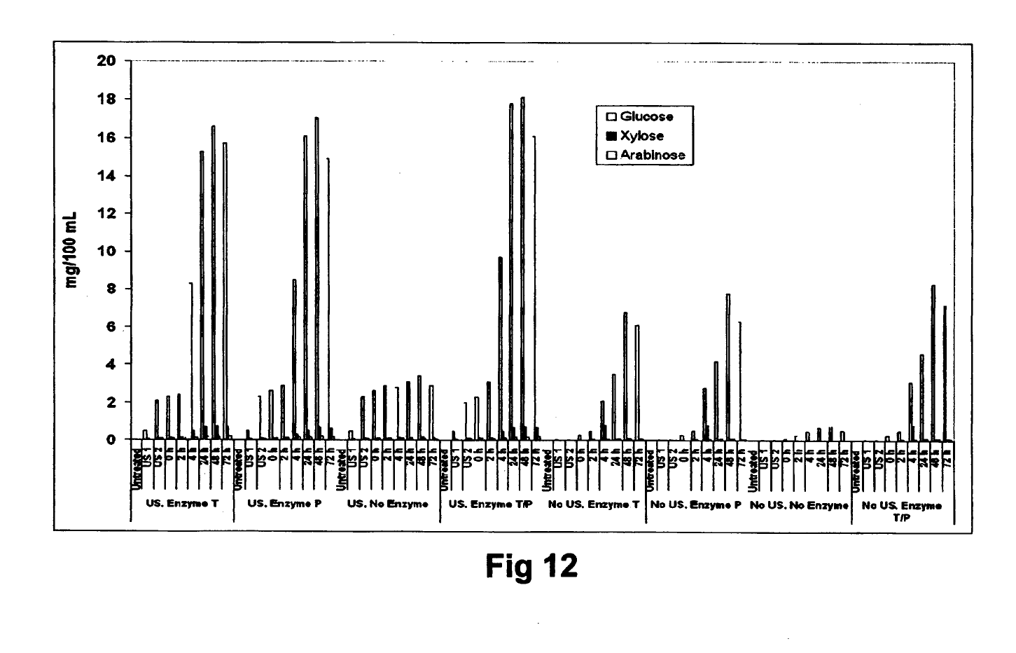

FIG. 12 shows sugars (analysed by GC after trimethylsilyl derivatisation) present in the liquid phase of wheat straw treated at 50° C. by US 40 kHz/10 min (US 1), followed by US 400 kHz/10 min (US 2), then inoculated with enzymes (0 h), and incubated (2-72 h) at 50° C. T=lignolytic enzymes obtained from Trametes hirsute/versicolor, P=lignolytic enzymes obtained from Phanerochaete chrysosporium; T/P=both lignolytic enzymes from both T and Pat 1:1 ratio.

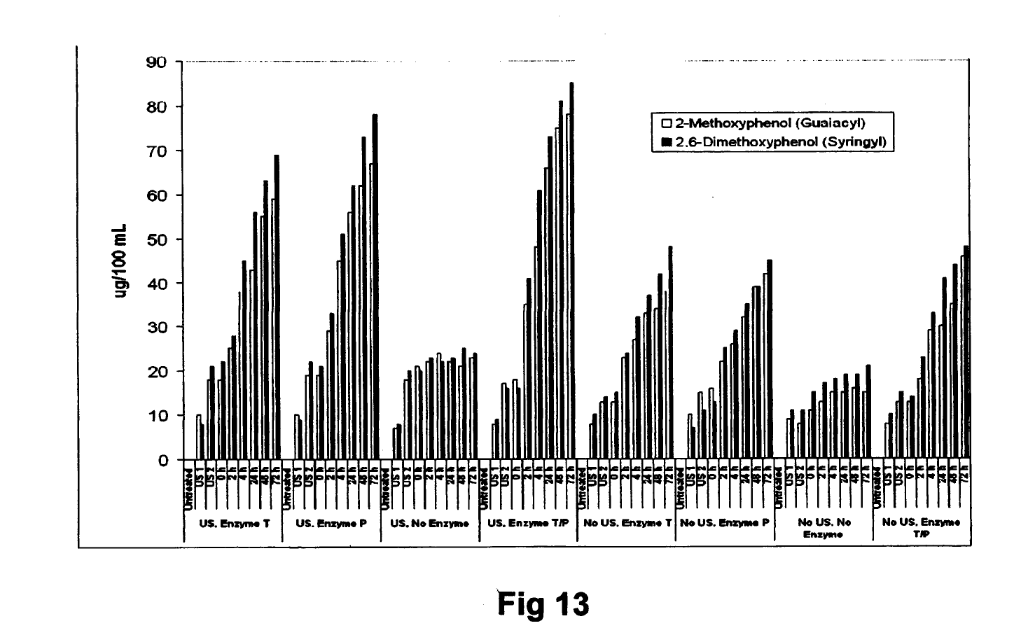

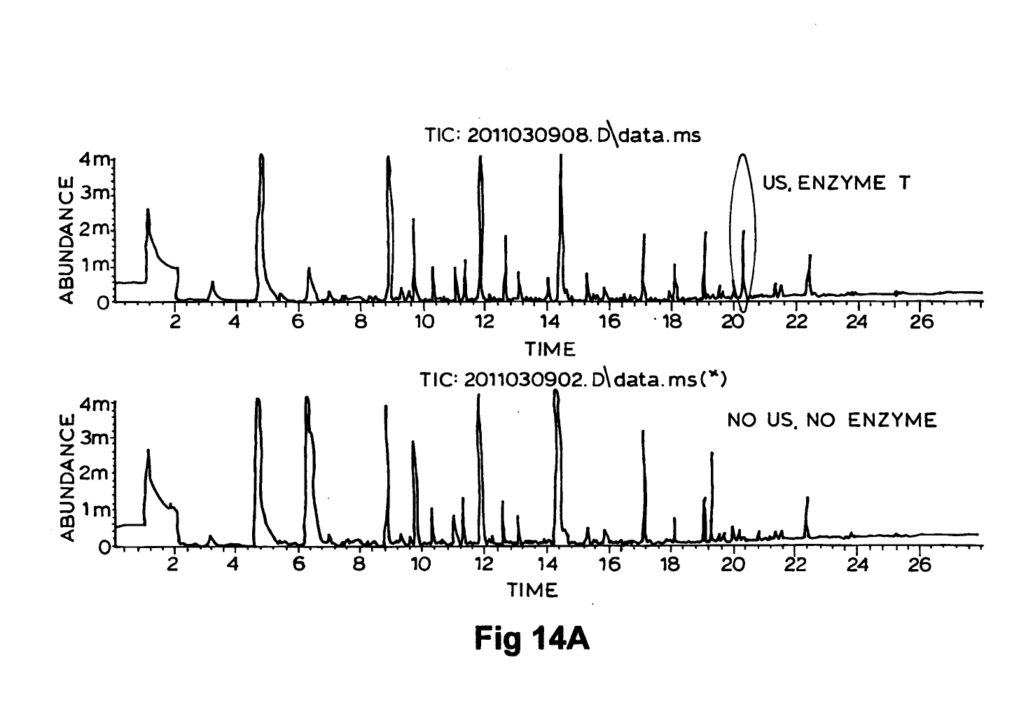

FIG. 13 shows phenolic compounds (analysed by GC after trimethylsilyl derivatisation) obtained from degradation of guaiacyl and syringyl lignin units. Analysis was performed on the liquid phase of wheat straw treated at 50° C. by US kHz/10 min (US 1), followed by US 400 kHz/10 min (US 2), then inoculated with enzymes (0 h), and incubated (2-72 h) at 50° C. T=lignolytic enzymes obtained from Trametes hirsute/versicolor P=lignolytic enzymes obtained from Phanerochaete chrysosporium; T/P=both lignolytic enzymes from both T and Pat 1:1 ratio.

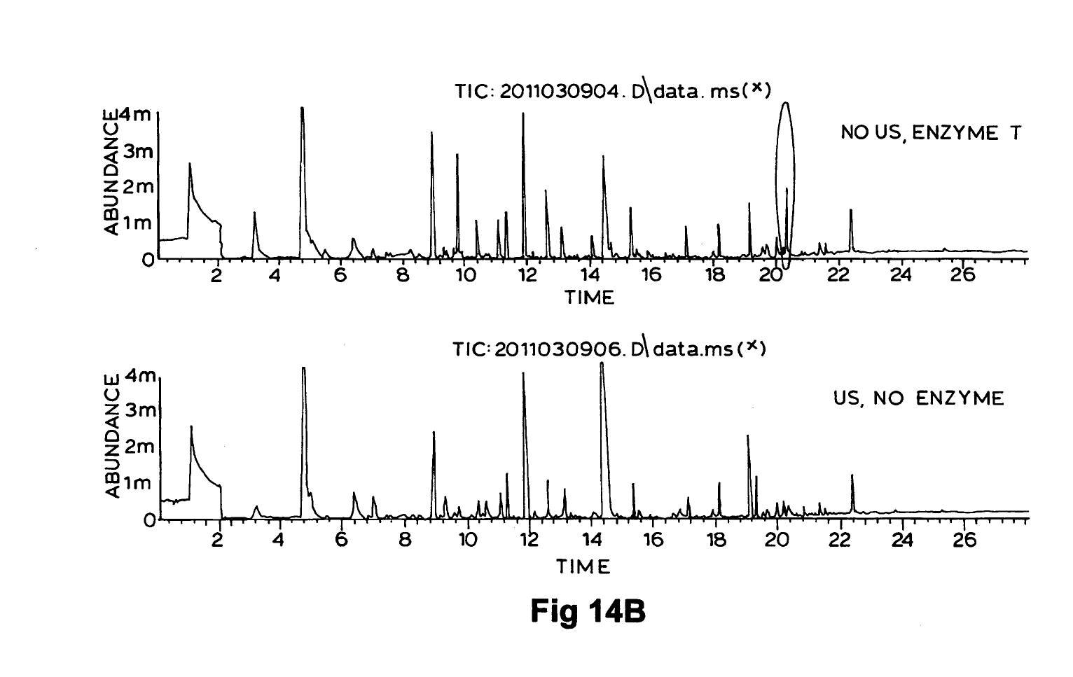

FIG. 14 GC chromatograms show compounds present in the headspace of the liquid phase of wheat straw treated at 50° C. by US 40 kHz/10 min followed by US 400 kHz/10 min, then inoculated with lignolytic enzymes and incubated (72 h) at 50° C. T=lignolytic enzymes obtained from Trametes hirsute/versicolor P=lignolytic enzymes obtained from Phanerochaete chrysosporium. Circled region is the dodecanal peak.

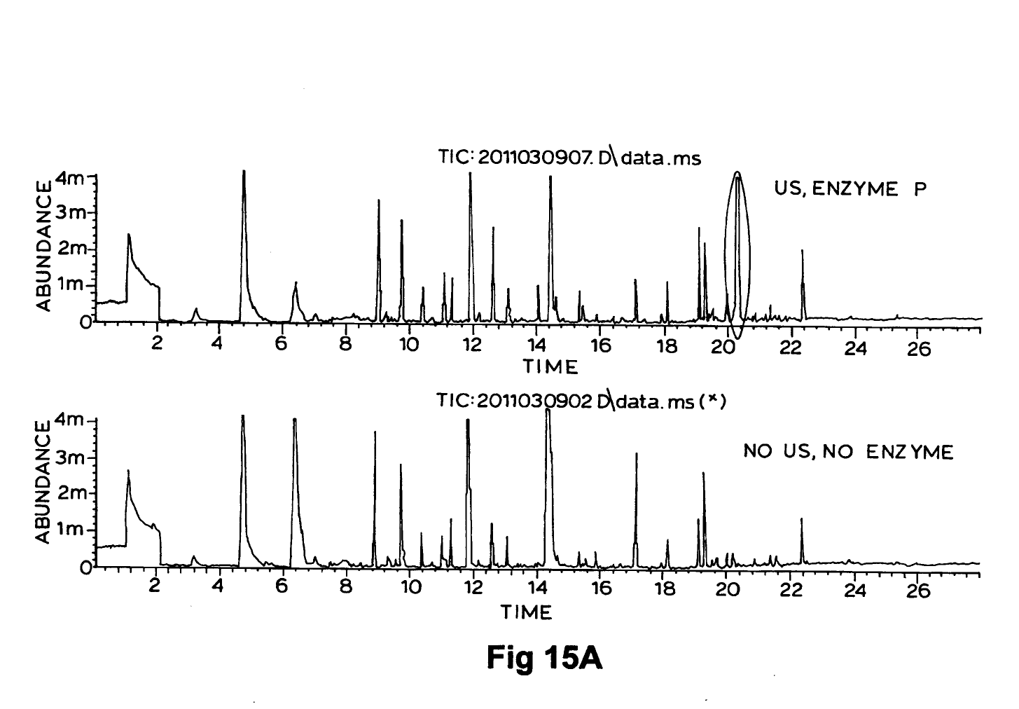

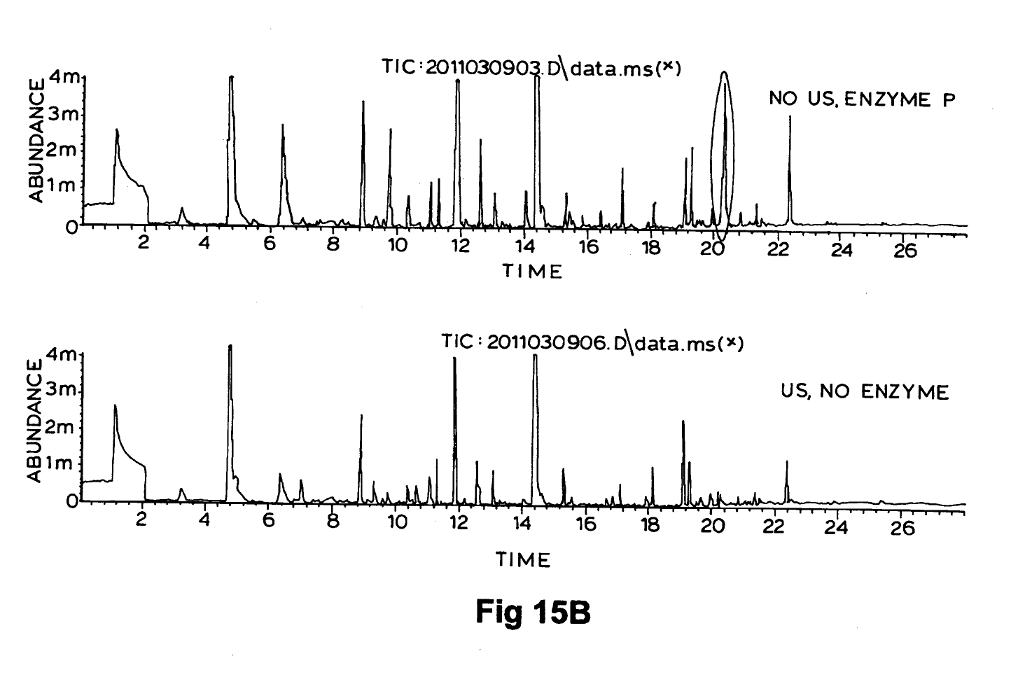

FIG. 15 GC chromatograms show compounds present in the headspace of the liquid phase of wheat straw treated at 50° C. by US 40 kHz/10 min followed by US 400 kHz/10 min, then inoculated with lignolytic enzymes and incubated (72 h) at 50° C. T=lignolytic enzymes obtained from Trametes hirsute/versicolor P=lignolytic enzymes obtained from Phanerochaete chrysosporium. Circled region is the dodecanal peak.

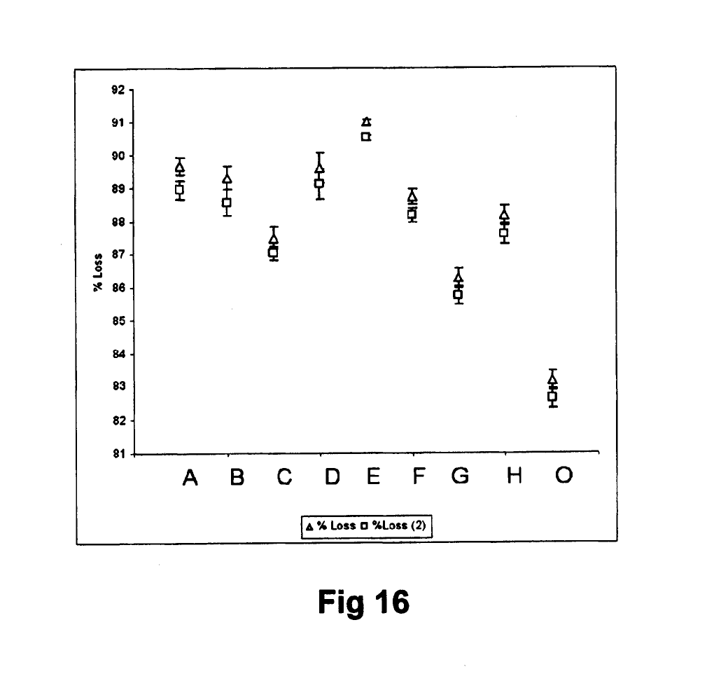

FIG. 16 shows the in vitro rumen digestibility with respect to non-digestible fibre of wheat straw. A-D=treated at 50° C. by US 40 kHz/10 min followed by US 400 kHz/10 min, then inoculated with or without lignolytic enzymes and incubated (72 h) at 50° C.; E-H incubated at 50° C. for 20 min, then inoculated with or without lignolytic enzymes and incubated (72 h) at 50° C. (ie no US pre-treatment). A & E=inoculated with lignolytic enzymes from Trametes hirsute/versicolor B & F=inoculated with lignolytic enzymes obtained from Phanerochaete chrysosporium; C & G=buffer only (no enzymes added); D & H=inoculated with lignolytic enzymes from both white rot fungi at 1:1 ratio; O=original wheat straw; Control=background from digestion blank.

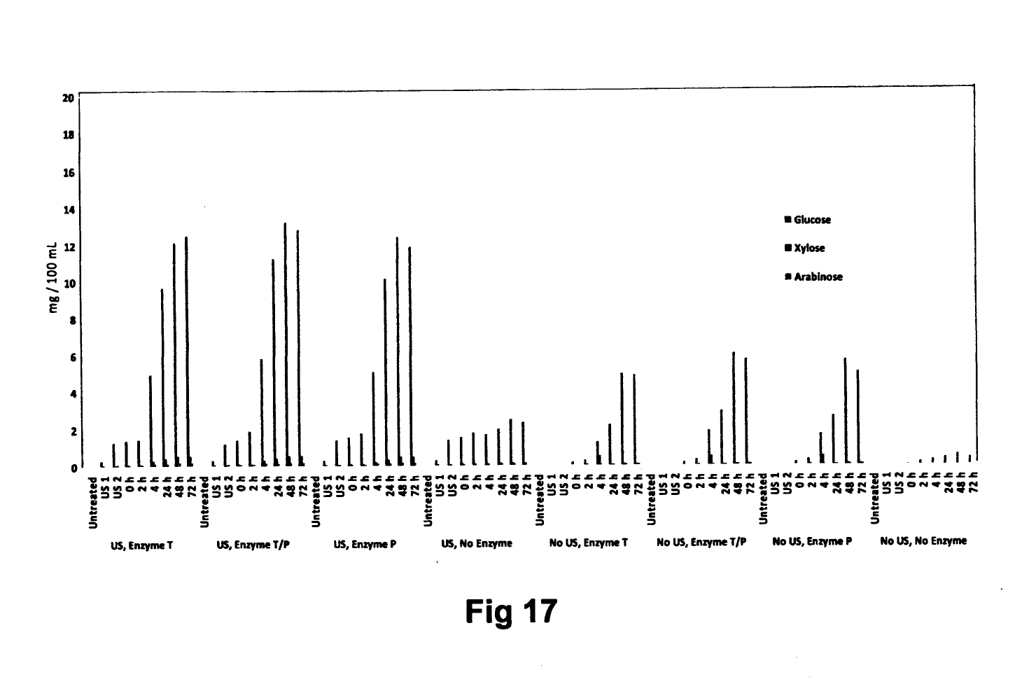

FIG. 17 shows sugars (analysed by GC after trimethylsilyl derivatisation) present in the liquid phase of rice straw treated at 50° C. by US 40 kHz/10 min (US 1), followed by US 400 kHz/10 min (US 2), then inoculated with enzymes (0 h), and incubated (2-72 h) at 50° C. T=lignolytic enzymes obtained from Trametes hirsute/versicolor P=lignolytic enzymes obtained from Phanerochaete chrysosporium; T/P=lignolytic enzymes from both T and P present at 1:1 ratio.

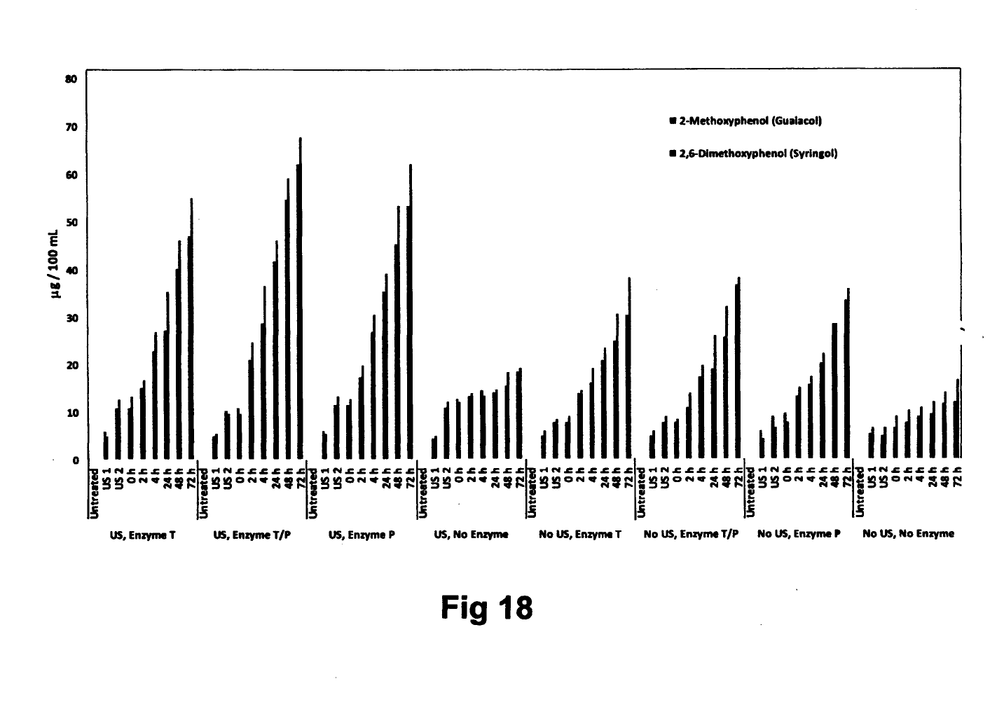

FIG. 18 shows phenolic compounds (analysed by GC after trimethylsilyl derivatisation) obtained from degradation of guaiacyl and syringyl lignin units. Analysis was performed on the liquid phase of rice straw treated at 50° C. by US 40 kHz/10 min (US 1), followed by US 400 kHz/10 min (US 2), then inoculated with enzymes (0 h), and incubated (2-72 h) at 50° C. T=lignolytic enzymes obtained from Trametes hirsute/versicolor P=lignolytic enzymes obtained from Phanerochaete chrysosporium; T/P=lignolytic enzymes from both T and P present at 1:1 ratio.

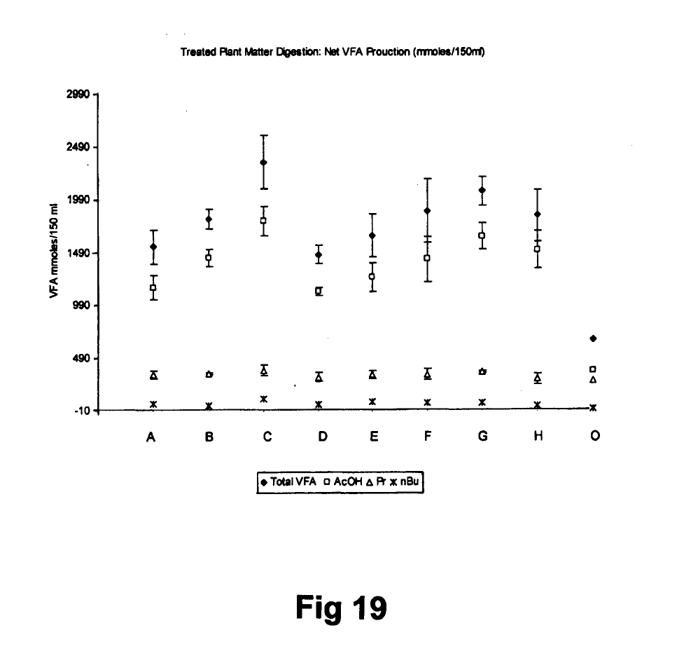

FIG. 19 shows the in vitro rumen digestibility with respect to production of individual and total volatile fatty acids (VFA) from rice straw. A-D=treated at 50° C. by US 40 kHz/10 min followed by US 400 kHz/10 min, then inoculated with or without lignolytic enzymes and incubated (72 h) at 50° C.; E-H incubated at 50° C. for 20 min, then inoculated with or without lignolytic enzymes and incubated (72 h) at 50° C. (ie no US pre-treatment). A & E=inoculated with lignolytic enzymes from Trametes hirsute/versicolor B & F=inoculated with lignolytic enzymes from both white rot fungi at 1:1 ratio; C & G=inoculated with lignolytic enzymes obtained from Phanerochaete chrysosporium; D & H=buffer only (no enzymes added), O=original rice straw.

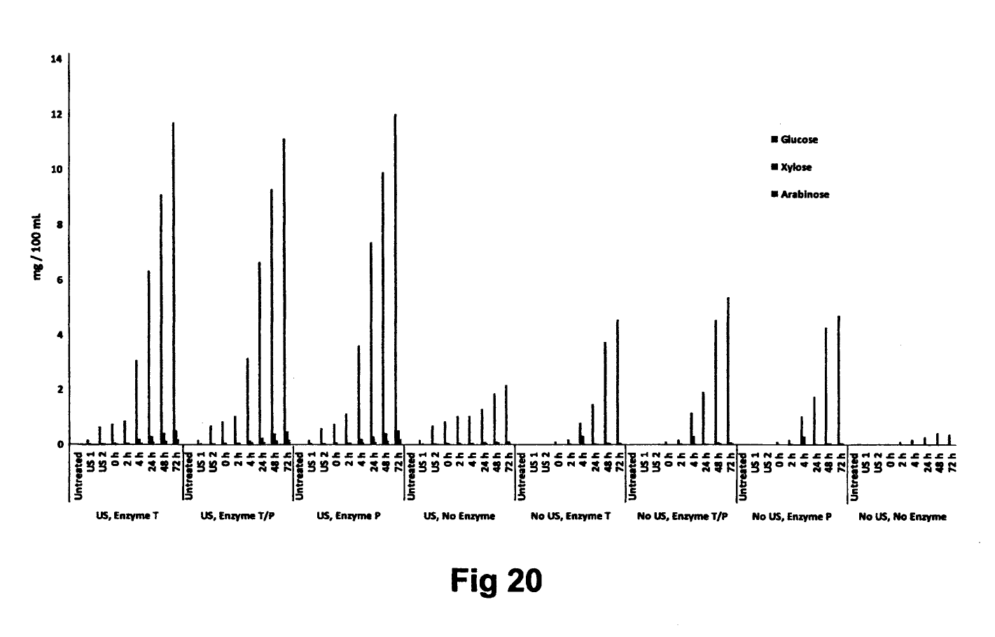

FIG. 20 shows sugars (analysed by GC after trimethylsilyl derivatisation) present in the liquid phase of cotton trash treated at 50° C. by US 40 kHz/10 min (US 1), followed by US 400 kHz/10 min (US 2), then inoculated with enzymes (0 h), and incubated (2-72 h) at 50° C. T=lignolytic enzymes obtained from Trametes hirsute/versicolor P=lignolytic enzymes obtained from Phanerochaete chrysosporium; T/P=lignolytic enzymes from both T and P present at 1:1 ratio.

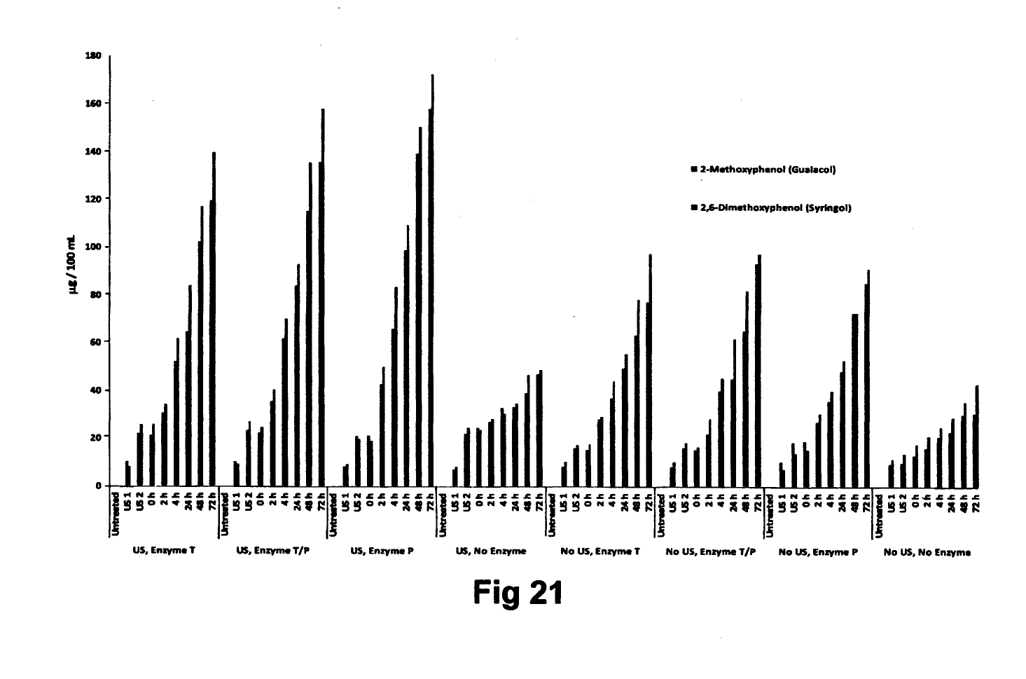

FIG. 21 shows phenolic compounds (analysed by GC after trimethylsilyl derivatisation) obtained from degradation of guaiacyl and syringyl lignin units. Analysis was performed on the liquid phase of cotton trash treated at 50° C. by US 40 kHz/10 min (US 1), followed by US 400 kHz/10 min (US 2), then inoculated with enzymes (0 h), and incubated (2-72 h) at 50° C. T=lignolytic enzymes obtained from Trametes hirsute/versicolor P=lignolytic enzymes obtained from Phanerochaete chrysosporium; T/P=lignolytic enzymes from both T and P present at 1:1 ratio.

The plant biomass is immersed in an aqueous bath or with sufficient moisture and ultrasonic transducer arrangements are applied with acoustic energy applied in the appropriate range, with or without subsequent physical interventions, followed by incubation with appropriate enzymes or fungi.

### EXAMPLE

i. Low frequency ultrasound to physically tease the structure apart following mechanical comminution or microwave disintegration, and physically blast waxy materials from the surface (cf ultrasonic cleaning), and
ii. Moderately high frequency ultrasound to sonochemically oxidise phenolic compounds and waxes, and
iii. Medium frequency ultrasound applied during the enzyme hydrolysis step to facilitate mass transfer through the boundary layers surrounding the enzymes without mechanically or sonochemically denaturing the enzymes.

Trials were conducted using pre-treatment with ultrasound and with or without prior microwave treatment to enhance the digestibility of wheat chaff in the presence of crude enzyme extracts from white-rot fungi, based on visual observations, total sugars and GC headspace analysis.

As shown in FIGS. 1 and 2 the feed stock was wheat chaff consisting of 8% solids in 2% acetate buffer, pH 5.

In both FIGS. 1 and 2 the microwave treatment is optional as it may decrease the extent of delignification.

The ultrasound treatments comprised a 3-step program consisting of sequential i) kHz, 600 s, ii) 270 kHz, 600 s, then iii) 80 kHz (50% power), 60 s every 1800 s for 144 cycles applied during the enzyme hydrolysis, with all steps operating at 35° C. (waterbath).

In the process of FIG. 2 the microwave treatment was High Power, 1 min. Samples were then cooled in cold (tap water).

In FIGS. 1 and 2, P refers to Phanerochaete chrysosporium extract added (1:1 v/v) to the samples prior to the 3^{rd} step (iii) of the ultrasonication treatment.

In FIGS. 1 and 2, T refers to Trametes hirsuta extract added (1:1 v/v) to the samples prior to the 3^{rd} step (iii) of the ultrasonication treatment.

FIGS. 3-9 illustrate the results of these treatments.

FIGS. 10 and 11 show
More extensive removal of fluorescent material from surface layer by ultrasound with enzyme extract (FIG. 10).
Enhanced visualisation of underlying striated cellulose microfibrils after ultrasound with enzyme extract (FIG. 10).
More extensive removal of cuticle (wax) (FIG. 11) after ultrasound and enhanced visualisation of underlying cellulose microfibrils.
Similar results were found in the samples treated by US with the enzyme extract obtained from Trametes hirsute/versicolor.

FIG. 12 shows
Synergistic increase in sugar production from wheat chaff with combined US/enzymes compared to US alone.
Increased sugar production from wheat chaff with enzymes (+US) compared to no enzymes (+US).
Increased sugar production from wheat chaff with US (no enzymes) compared to no US (no enzymes).
Overall, treatment of wheat chaff by US alone increased sugar production, enzyme alone increased sugar production and combined US/enzyme caused a synergistic increase in sugar production.

FIG. 13 shows
Synergistic increase in phenolic compounds released from wheat chaff with combined US/enzymes compared to US alone.
Increased phenolic compounds released from wheat chaff with enzymes (+US) compared to no enzymes (+US).
Increased phenolics released from wheat chaff with US (no enzymes) compared to no US (no enzymes).
Overall, treatment of wheat chaff by US alone increased phenolics, enzyme alone increased phenolics, and combined US/enzyme caused a synergistic increase in phenolics

FIGS. 14 & 15 show no differences in the GC profile. The major difference was in the amount of dodecanal generated, and this could be due to a cuticle-degrading enzyme [US did not affect its activity].

FIG. 16 shows a 3-8% increase in the in vitro digestibility of the treated samples compared to the original wheat chaff. Generally, the samples which had been pre-treated with ultrasound showed a higher increase in digestibility than those that had not been US pre-treated.

FIG. 17 shows
Synergistic increase in sugar production from rice chaff with combined US/enzymes compared to US alone.
Increased sugar production from rice chaff with enzymes (+US) compared to no enzymes (+US).
Increased sugar production from rice chaff with US (no enzymes) compared to no US (no enzymes).
Overall, treatment of rice chaff by US alone increased sugar production, enzyme alone increased sugar production and combined US/enzyme caused a synergistic increase in sugar production.

FIG. 18 shows
Synergistic increase in phenolic compounds released from rice chaff with combined US/enzymes compared to US alone.
Increased phenolic compounds released from rice chaff with enzymes (+US) compared to no enzymes (+US).
Increased phenolics released from rice chaff with US (no enzymes) compared to no US (no enzymes).
Overall, treatment of rice chaff by US alone increased phenolics, enzyme alone increased phenolics, and combined US/enzyme caused a synergistic increase in phenolics

FIG. 19 shows an approximate 2 to 3 fold increase in the in vitro digestibility of the treated samples compared to the original rice chaff. The largest increase in digestibility of the rice straw was obtained by US pre-treatment of rice straw followed by incubation with the enzyme extract obtained from Phanerochaete chrysosporium.

FIG. 20 shows
Synergistic increase in sugar production from cotton trash with combined US/enzymes compared to US alone.
Increased sugar production from cotton trash with enzymes (+US) compared to no enzymes (+US).
Increased sugar production from cotton trash with US (no enzymes) compared to no US (no enzymes).
Overall, treatment of cotton trash by US alone increased sugar production, enzyme alone increased sugar production and combined US/enzyme caused a synergistic increase in sugar production.

FIG. 21 shows
Synergistic increase in phenolic compounds released from cotton trash with combined US/enzymes compared to US alone.
Increased phenolic compounds released from rice chaff with enzymes (+US) compared to no enzymes (+US).
Increased phenolics released from cotton trash with US (no enzymes) compared to no US (no enzymes).
Overall, treatment of cotton trash by US alone increased phenolics, enzyme alone increased phenolics, and combined US/enzyme caused a synergistic increase in phenolics.

Findings from the trials reveal:
Lignin degradation products (monomeric phenolic compounds) were identified
Numerous alcohols, acids and ester compounds were also presents indicating fermentation of the sugars produced by the enzymic degradation of cellulose/hemi-cellulose
Ultrasonic treatment of the substrate wheat chaff enhanced enzymatic degradation
Microwave treatment, with or without ultrasonic treatment, had a small suppression effect on the phenolic degradation products produced by Phanerochaete crysosporium extract. But microwave treatment seems to have a major suppressive effect on lignin degradation and fermentation of the derived products in the case of Trametes hirsuta extract.
A significant increase in the invitro digestibility of treated wheat chaff and rice chaff
A synergistic increase in phenolics and sugars released from wheat chaff, rice chaff and cotton trash by combined ultrasound and enzyme hydrolysis.

From the above it can be seen that the present invention provides beneficial improvements in the treatment of lignocellulosic materials.

Those skilled in the art will realise that the invention can be implemented in embodiments other than those described without departing from the core teachings of this invention.

1. A method of processing a lignocellulosic biomass, wherein the plant biomass is immersed in an aqueous bath or provided with sufficient moisture and then treated with acoustic energy followed by incubation with appropriate enzymes or fungal extracts wherein the acoustic treatment includes
i) applying a low frequency ultrasound for at least 300 seconds
ii) applying a moderately high frequency ultrasound for at least 300 seconds, either subsequent to the low frequency treatment or simultaneously with the low frequency treatment.

2. A method of claim 1, wherein the fungal extracts are from Phanerochaete chrysosporium and/or Trametes hirsute/vesicolor.

3. A method of claim 1 further comprising applying a medium frequency ultrasound for at least 300 seconds during the enzyme incubation.

4. A method of claim 3, wherein the low frequency is from 10 to 60 kHz the moderately high frequency is above 200 kHz and the medium frequency is from 60 to 120 kHz.

5. A method of claim 4, wherein the acoustic treatment steps are sequential.

6. A method of claim 4, wherein the acoustic treatments are applied simultaneously.

7. A method of claim 3, wherein each of the acoustic treatment steps are carried out for 600 s.

8. A method of claim 3, wherein pulsed ultrasound is applied during the enzyme incubation step.

9. A method of claim 8, wherein the pulsed ultrasound is performed at 80 kHz for 1 min every 30 min over 2-72 hours at 37-50° C.

10. A method of claim 1, wherein the treatments are carried out at a temperature over the range 37-50° C.

11. A method of claim 1, wherein the sonication power is 80-100%.

12. A method of claim 8, wherein the sonication power is 50%.

13. A method of claim 3, wherein the enzyme incubation step is carried out for 2-72 hours.

14. Animal feed derived from lignocellulosic biomass processing according to claim 1.

15. A method of claim 2 further comprising applying a medium frequency ultrasound for at least 300 seconds during the enzyme incubation.

16. A method of claim 15, wherein the low frequency is from 10 to 60 kHz the moderately high frequency is above 200 kHz and the medium frequency is from 60 to 120 kHz.

17. A method of claim 9, wherein the sonication power is 50%.

18. Animal feed derived from lignocellulosic biomass processing according to claim 2.

19. Animal feed derived from lignocellulosic biomass processing according to claim 3.

20. Animal feed derived from lignocellulosic biomass processing according to claim 15.
